(19) United States
(12) Patent Application Publication
(10) Pub. No.: US 2003/0228458 A1
(43) Pub. Date: Dec. 11, 2003

(54) Perforated closed-cell foamed material and method for manufacture

(76) Inventor: Mario Lorini, King City (CA)

Correspondence Address: SHOEMAKER AND MATTARE, Suite 1203, 2001 Jefferson Davis Highway, Arlington, VA, 22202-0286, US

(21) Appl. No.: 10/166,103

(22) Filed: Jun. 11, 2002

(51) Int. Cl. B32B 3/26

(52) U.S. Cl. 428/314.4; 428/131; 428/138; 428/133

(57) ABSTRACT

A method of manufacturing a layer of material adapted for use as carpet underlay (though not restricted thereto), from a sheet having two opposed surfaces with one surface being intended to contact the carpet when used for that purpose. The method involves partly perforating the sheet by inserting, through one said surface, an array of needles, thus providing passageways for the escape of air from the cells when the layer is compressively loaded, and for the return of air to the cells when the load is removed.

This invention relates generally to a method of manufacturing sheets of material that can be utilized as carpet underlay, without being restricted to that application. It also relates to the material itself.

### BACKGROUND OF THIS INVENTION

Closed-cell foamed plastic materials are in wide use for insulation, packaging and flooring applications. Such materials must generally exhibit the properties of cushionability, flexibility and durability, in order to achieve their full utility. It is generally found that the material of a closed-cell foamed sheet, after compression, tends to take a long time to decompress, making it undesirable for many user applications, such as insulation, packaging and flooring (underlay). To assist the foamed material in decompression, larger cell structures can be utilized, but this continues to limit the usefulness of the foamed material in many insulating, packaging and flooring applications.

### GENERAL DESCRIPTION OF THIS INVENTION

In a general way, this invention provides a method for producing an externally and internally molded layer of foamed material, with the capability of decompressing in a short period of time, and the foamed layer thus created.

More particularly, this invention provides a method of manufacturing a layer of material from a sheet of plastic material having generally closed cells, the sheet having two opposed surfaces; the method comprising partly perforating said sheet by inserting part-way into the sheet, through at least one of said surfaces, an array of needles, thereby providing passageways for the escape of air from at least some of the cells when a load is applied to the layer, and for the return of air to the cells when the load is removed.

Further, this invention relates to a layer comprising a sheet of generally closed-cell plastic material, the sheet having two opposed surfaces, said sheet having a plurality of passageways extending part-way into the sheet, from one of said surfaces, the passageways being the result of penetration by an array of needles, said passageways allowing for the escape of air from the cells when a load is applied to the layer, and for the return of air to the cells when the load is removed.

### BRIEF DESCRIPTION OF THE DRAWINGS

One embodiment of this invention is illustrated in the accompanying drawings, in which like numerals denote like parts throughout the several views, and in which:

FIG. 1 is a perspective view showing a closed-cell plastic layer at the bottom, and at the top a platen supporting a plurality of needles;

FIG. 2 is a vertical sectional view of the two components shown in FIG. 1, after the upper component has been brought down against the surface of the plastic layer underneath;

FIG. 3 is a vertical sectional view through the lower component in FIGS. 1 and 2, into which the needles fixed to the upper platen have penetrated; and

FIG. 4 is a partially elevational, partly sectional, view of a roller useful in carrying out this invention.

### DETAILED DESCRIPTION OF THE DRAWINGS

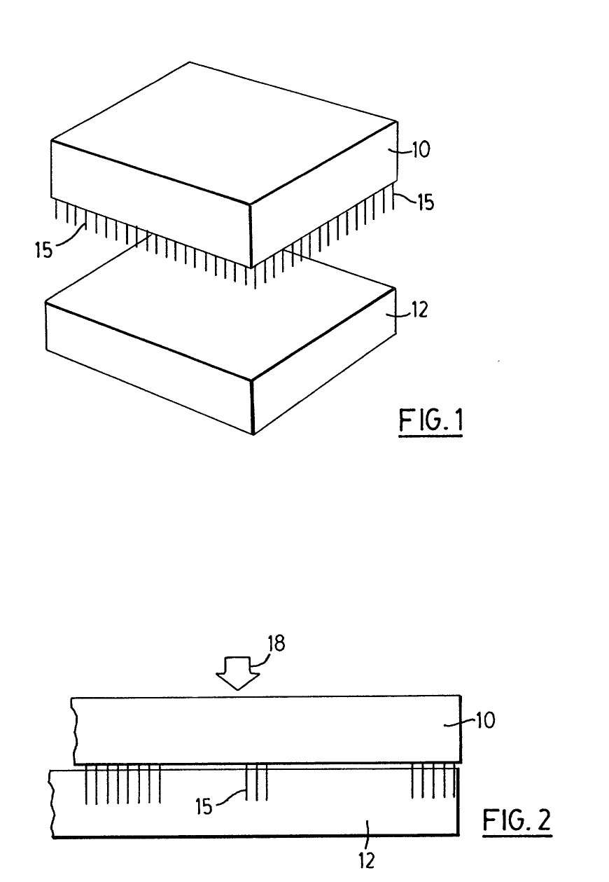

Attention is first directed to FIG. 1, which shows a vertically moveable platen 10, rectangular in plan view, provided so as to be directly above the position of a workpiece 12, which is supported horizontally by a table or other supporting means (not shown).

Projecting downward from the bottom surface of the platen 10 is a plurality of needles 15.

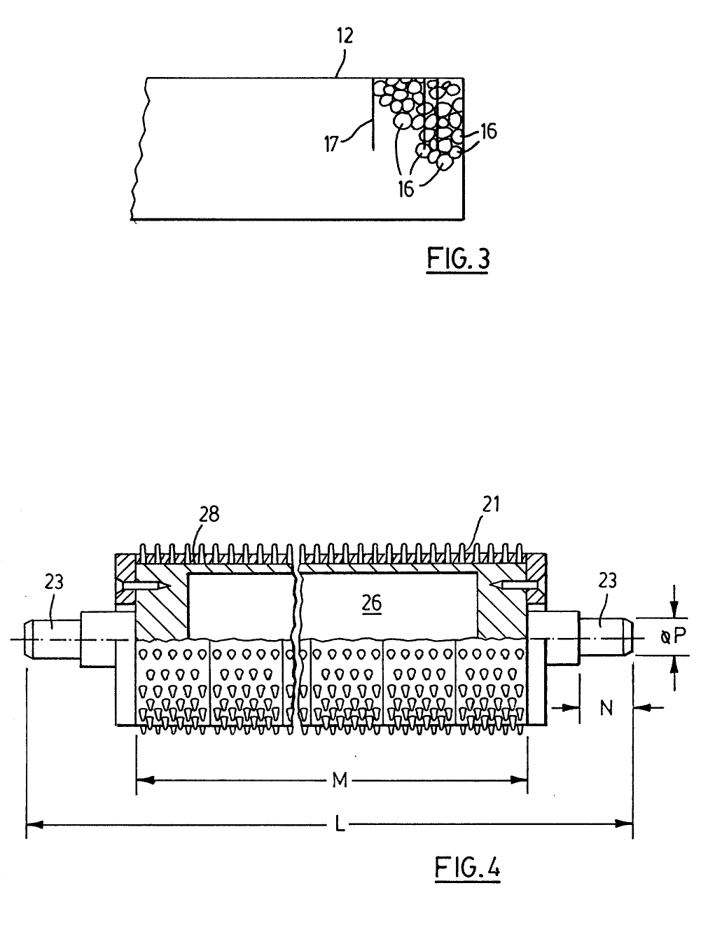

Attention is directed to FIG. 3, which is a sectional view showing a plurality of closed cells 16 of plastic material.

The arrow 18 in FIG. 2 shows the downward movement of the platen 10 to its “closed” position against the top of the workpiece 12. It will be noted, particularly from FIG. 3, that the needles have penetrated approximately half-way through the workpiece 12, leaving needle tracks 17.

Attention is now directed to FIG. 4, which shows an alternative modality for causing pins to penetrate into the closed cells 16 of plastic material.

In FIG. 4, a roller 21 exhibits a mounting axle 23, which can be mounted for rotation in the usual manner. The roller 21 has a hollow interior, including a hollow cylindrical portion 26. A “plate” 28, supporting a plurality of radially outwardly extending pins 29, is wrapped around the entire periphery of the roller 21, and secured in place by conventional means.

Thus, the method of this invention involves partly perforating a sheet represented by the workpiece 12, by inserting into the sheet, through one face thereof, an array of needles, thereby providing passageways for the escape of air from the cells when the layer is loaded (squeezed), and for the return of air to the cells when the load is removed.

In a preferred embodiment, the plastic material of the workpiece 12 is polyethylene.

For underlay applications it is preferred that the array of needles be generally uniformly distributed with at least about 49 needles per square inch. (The density of the needles will be discussed further below.)

It should be made clear that the expression “generally uniformly distributed array” includes both a random and a regular geometric array.

Looking at FIG. 4, it is clear that the needles are arranged in a regular geometric array (lined up circumferantially and longitudinally). Anything other than a strict geometric array can be referred to as a “random array”.

It will be further understood that some applications are better using a geometric array, while a random array may be preferable in other applications. Also, a non-uniform distribution may be best in yet other applications. However when uniform needle density is required, the easiest and surest way to achieve it is to place the needles in a repeating geometric array.

In a preferred embodiment, the passageways 15 extend substantially half-way into the sheet.

It is further desirable for the needles to be relatively fine, and particularly to have a diameter between about 30 and about 50 thousandths of an inch. Needles with diameters below 30 thou are subject to breakage, while needles with diameters over 50 thou tend to “rip” the plastic material.

A particular use for the layer defined above is as a carpet underlay wherein the face in contact with the carpet is the one through which the pins 15 are inserted in order to provide air passageways for the escape and return of air to the otherwise closed cells 16.

We have found that a layer of sheet material treated as described above functions quite satisfactorily as an underlay for carpet. The company Dupont Inc. has devised a “spring-back” test to determine such suitability. In the test, a one-inch diameter dowel with a squared end is allowed to press downward against the combination of underlay and carpet under a load of 25 lbs. This pressure is maintained for 24 hrs, and then is removed. For a material to “pass” this test, the depression must recover at least 80% of its initial height within 48 hrs.

We have also found that, the less the number of needles per square inch, the longer it takes for the material to “spring back” and recover the required 80% of its original height, this being presumably due to the fact that a smaller number of needles will puncture a smaller number of cells.

It has also been found that, without the pin perforations, the material recovers by only 25% in 48 hours (thus failing the test), whereas when the perforations are present with a coverage (density) of at least 49 pins per square inch (a 7×7 array), the test is passed. Tests show that arrays of 81 (a 9×9 array) and 120 (almost an 11×11 array) also pass, whereas a perforation distribution of only 36 per square inch (a 6×6 array) fails to pass the test.

A variation of this development involves laminating the foam layer with a sheet of other suitable material, such as plastic, wood, metal, and the like. The lamination typically involves the application of heat in order to “weld” the two layers together. For this reason, the perforation of the foam layer should be done after the lamination is completed, to avoid “closing in” the needle tracks 17, and thus blocking their function.

While one embodiment of this invention has been illustrated in the accompanying drawings and described hereinabove, it will be evident to those skilled in the art that changes and modifications may be made therein, without departing from the essence of this invention, as set forth in the appended claims.

The embodiments of the invention in which an exclusive property or privilege is claimed are defined as follows:

1. A method of manufacturing a layer of material from a sheet of plastic material having generally closed cells, the sheet having two opposed surfaces, the method comprising partly perforating said sheet by inserting part-way into the sheet, through at least one of said surfaces, an array of needles, thereby providing passageways for the escape of air from at least some of the cells when a load is applied to the layer, and for the return of air to the cells when the load is removed.

2. The method claimed in claim 1, in which the said plastic material is polyethylene.

3. The method claimed in claim 1, in which said array is generally uniformly distributed and has at least about 49 needles per square inch.

4. The method claimed in claim 2, in which the array is generally uniformly distributed and has at least about 49 needles per square inch, each needle being a tubular shaft with a diameter between about 30 and about 50 thousandths of an inch.

5. The method claimed in claim 1, in which the array of needles is a random array.

6. The method claimed in claim 1, in which the array of needles is a regular geometric array.

7. The method claimed in claim 1, in which the step of inserting the needles utilizes a roller exhibiting a cylindrical surface from which the needles project substantially radially outward, the sheet being at least partially entrained around said cylindrical surface of the roller to cause the needles to penetrate the sheet.

8. A layer comprising a sheet of generally closed-cell plastic material, the sheet having two opposed surfaces, said sheet having a plurality of passageways extending part-way into the sheet, from one of said surfaces, the passageways being the result of penetration by an array of needles, said passageways allowing for the escape of air from the cells when a load is applied to the layer, and for the return of air to the cells when the load is removed.

9. The layer claimed in claim 8, in which the plastic material is polyethylene, and in which the passageways extend substantially half-way into the sheet.

10. The layer claimed in claim 8, in which said array is generally uniformly distributed and has at least about 49 needles per square inch.

11. The layer claimed in claim 10, in which the generally uniformly distributed array of needles has at least about 49 needles per square inch, each needle having a tubular shaft with a diameter not greater than about 50 thousandths of an inch, and in which the passageways extend substantially half-way into the sheet.

12. The layer claimed in claim 10, in which the generally uniformly distributed array of needles is a random array.

13. The layer claimed in claim 10, in which the generally uniformly distributed array of needles is a regular geometric array.

14. The layer claimed in claim 12, in which said generally uniformly distributed array has at least about 60 needles per square inch.

15. The layer claimed in claim 13, in which said generally uniformly distributed array has at least about 60 needles per square inch.

16. The use of the layer claimed in claim 8 as a carpet underlay, with said one of said surfaces being uppermost and in contact with the carpet.

17. The method claimed in claim 1, in which, prior to the perforation of the sheet, the sheet has laminated thereto a layer of a material selected from the group consisting of: plastic, wood, metal.

18. A layer as claimed in claim 8, which is laminated to a sheet consisting of a material selected from the group consisting of plastic, wood, metal, said last-mentioned sheet being laminated against the surface of the first-mentioned sheet which is opposite the surface through which the array of needles passes.
